(19) United States
(12) Patent Application Publication
(10) Pub. No.: US 2004/0110496 A1
(43) Pub. Date: Jun. 10, 2004

(54) Method for identifying at least one port

(75) Inventor: Roman Kolar, Kranj (SI)

Correspondence Address: Kevin R. Spivak, Morrison & Foerster LLP, Suite 300, 1650 Tysons Boulevard, McLean, VA, 22102, US

(73) Assignee: Siemens Aktiengesellschaft, Munich (DE)

(21) Appl. No.: 10/366,700

(22) Filed: Feb. 14, 2003

(30) Foreign Application Priority Data
Feb. 15, 2002 (DE) 10206400.8

(51) Int. Cl. H04M 3/42

(52) U.S. Cl. 455/417; 379/211.01

(57) ABSTRACT

Method for forwarding at least one call which arrives at a connection (A), in which case, when the at least one call arrives during an active call connection to a second connection (B), the connection to the second connection (B) and the incoming call are held and a call is set up between the connection (A) and a further connection (D), with the call being passed to the further connection (D) and the call connection to the second connection (B) being resumed.

The invention relates to a method for forwarding at least one call, which arrives at a first connection in a telecommunications system and is intended for another connection, to the other connection.

The invention furthermore relates to the telecommunications system having at least four connections which each have at least one associated telecommunications terminal, having at least one switching center which is set up for holding and forwarding calls.

As is known, an arriving connection request can be signaled audibly or visually during an existing connection. This service feature results in the subscribers remaining accessible to others, even during a call. The ISDN service feature of call waiting is also offered with a so-called multiple appliance connection, and is carried out by telecommunications systems. The person being called can normally read the telephone number of the caller on a display and can react immediately to the call waiting by interrupting the existing connection and keeping it on hold in order to pick up the second call. Switching backward and forward between the previous call partner and the call-waiting subscriber is referred to as call brokering. In this case, only those subscribers who currently have an existing active connection can communicate with one another. The waiting subscriber is held in the exchange until the call is resumed. The connection charges are normally incurred by the subscriber who has initiated the setting up of the connection by his dialing process. If the call-waiting subscriber is actively connected to the existing connection, this is referred to as a conference of three. During the call waiting process, the call-waiting subscriber hears a dialing tone. Should the subscriber not respond to the connection request from the call waiting subscriber within 30 seconds, the latter hears a busy tone instead of the dialing tone.

A situation can occur in which, during call brokering, the arriving call from the call-waiting subscriber is actually intended for a further, external connection, so that call diversion to this connection would be necessary. In this context, an external connection is a connection to which there is no connection from the connection receiving the call at the time when the call-waiting call was received.

However, this cannot be accomplished by the known methods, such as call brokering.

One object of the invention is therefore to overcome this disadvantage of the known methods.

This object is achieved according to the invention by a method of the type mentioned initially in that when the at least one call arrives at the first connection while the first connection is actively engaged in a call to a second connection, the connection to the second connection and the call arriving at the first connection are held and a call is set up between the first connection and the other connection for which the call arriving at the first connection is intended, with the call being passed from the first connection to the other connection once the call has been set up between the first connection and the other connection, and in which case the call connection which was placed on hold between the first connection and the second connection can be picked up once again.

Calls which arrive at the first connection are advantageously held, on request by this connection, in a switching center which is associated with this connection.

In one advantageous embodiment of the invention, the first connection transmits a request to the switching center to forward the call which has been held to the third connection.

A telecommunications system of the type mentioned initially is particularly suitable for carrying out the method according to the invention, in which the telecommunications system is set up such that, when at least one call arrives for a first connection while the first connection is actively engaged in a call with a further connection, the connection to the second connection is held, and the call arriving at the first connection is held on request, and, after entering a telephone number which is associated with the further connection, the arriving call is forwarded to the further connection and the call connection between the first connection and the second connection can be resumed.

In one advantageous variant of the invention, a switching center is provided, which is associated with the first connection and is set up for holding calls which arrive for the first connection, on request by this connection.

Further advantages can be achieved by the telecommunications system being set up for transmitting to the switching center a request from the first connection to forward the held call to the third connection.

The invention together with further advantages will be explained in more detail in the following text with reference to an exemplary embodiment which does not imply any restriction and is illustrated in the drawing, in which:

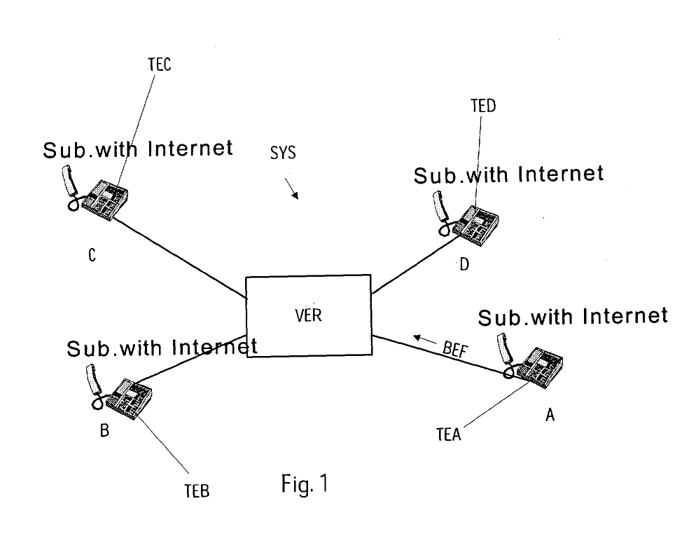

FIG. 1 shows a telecommunications system according to the invention, and

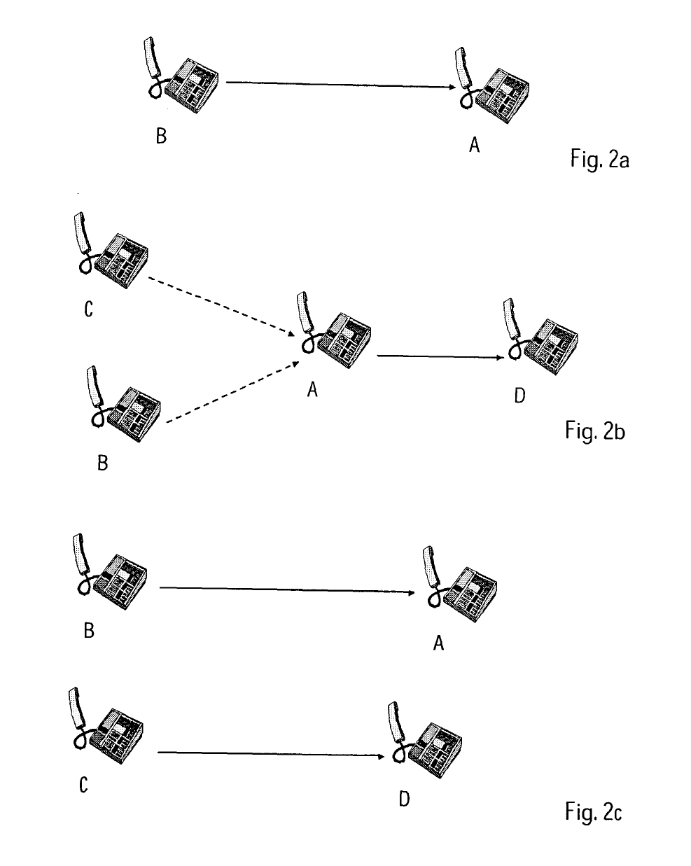

FIGS. 2a, 2b, 2c show a schematic procedure for the method according to the invention.

As shown in FIG. 1, a telecommunications system SYS according to the invention has at least four connections A, B, C, D, which have at least one associated switching center VER. The switching center VER may, for example, be an ISDN or Centrex switching center. Furthermore, each of the connections A, B, C, D has an associated telecommunications terminal TEA, TEB, TEC, TED.

In Centrex groups (“Central Office Exchange Service”; in this context also see Bocker, Peter: Digital networks for speech, text, data and video multimedia communication, Springer; 1997), it is possible to combine existing normal individual connections in a public telecommunications network via a Centrex switching center to form a private branch exchange or telecommunications system.

One example of a Centrex switching center is the so-called EDDS (“Electronic Digital Dialing System”) from the applicant, which essentially comprises a coordination processor, a number of (digital) subscriber line units (line units or digital line units), line trunk groups (LTG) for connection of subscriber lines and connecting lines, a so-called switching network (SN) for passing on the connections, as well as a functional unit for controlling the network for the central signaling channels (CCNC, common channel signaling network).

Different terminals, for example analog telephones, ISDN telephones, or else complete private branch exchange systems or radio telephones such as DECT mobile radios, can be connected via the appropriate interfaces. Furthermore, it is also possible to integrate GSM mobile radios in the Centrex telephone number plan.

The Centrex functionality can be implemented by means of software modules so that no hardware conversions are required in existing switching centers. The software emulation of a private telecommunications system in an ISDN switching center offers the subscribers in a Centrex group telephone services such as short dialing, pick-up call, automatic callback, call waiting, call brokering, call diversion, conference circuit, charging and call number display, as is normal and known in ISDN telecommunications systems, without having to actually physically provide such a telecommunications system for the subscribes.

FIG. 2a shows a call connection between a first connection A and a second connection B. If a third connection C transmits a call request to the connection A, then the connection A can identify on a display on a terminal associated with it that the connection C is waiting to call it. If the connection A picks up the call to the connection C, then it must interrupt the existing connection to the connection B (FIG. 2b). In order to make it possible to resume the connection to the connection B at some later time, this connection can be held by the switching center VER. To do this, an appropriate command must be entered via the terminal TEA of the connection A, and must be transmitted to the switching center.

If it turns out during the course of the call to the subscriber of the connection C that this subscriber wishes to speak to a subscriber other than the subscriber of the connection A, then the subscriber of the connection A can transmit a command to hold and forward to the switching center VER the connection to the connection C. Thus, at this time, the switching center holds two connections for the connection A, namely the original connection for the connection B and the call which was picked up later to the connection C.

The telephone number of the connection D can now be entered via the telecommunications terminal TEA associated with the connection A, this being the telephone number to which the subscriber of the connection C should be connected. His telephone number is transmitted from the connection A to the switching center.

After setting up a call to the corresponding opposing station C, the subscriber of the connection A can transmit a command BEF (access code) to the switching center (VER) in order to set up the connection between the connection C and the connection D, although it is not absolutely essential for a call connection to be produced between the connections A and D (FIG. 1). In principle, it is sufficient for the command BEF for call diversion for the held call ANR of the connection C to be entered in the phase of call tone signaling between the connection A and the connection D. The switching center VER can use the telephone number of the connection D, which was transmitted to it from the connection A, to pass on the call from the connection C to the connection D (FIG. 2c).

The connection between the connection B and the connection A, which is being held by the switching center VER, may then be resumed, for example after transmitting an appropriate request from the connection A to the switching center VER, or automatically by the switching center VER, so that, in the example shown here, two call connections exist after the end of the call forwarding process according to the invention, namely between the connections A and B and the connections C and D.

1. A method for forwarding at least one call, which arrives at a first connection (A) in a telecommunications system (SYS) and is intended for another connection (D), to the other connection (D), characterized in that, when the at least one call arrives at the first connection (A) while the first connection (A) is actively engaged in a call to a second connection (B), the connection to the second connection (B) and the call arriving at the first connection (A) are held and a call is set up between the first connection (A) and the other connection (D) for which the call arriving at the first connection (A) is intended, with the call being passed from the first connection (A) to the other connection (D) once the call has been set up between the first connection and the other connection (D), and in which case the call connection which was placed on hold between the first connection and the second connection (B) can be picked up once again.

2. The method as claimed in claim 1, characterized in that during an active call with another connection, incoming calls to the first connection (A) are held, on request by the first connection (A), in a switching center (VER) which is associated with this connection (A).

3. The method as claimed in claim 2, characterized in that the first connection (A) transmits a request to the switching center (VER) to forward the call which has been held to the third connection (D).

4. The telecommunications system (SYS) having at least four connections (A, B, C, D) which each have at least one associated telecommunications terminal (TEA, TEB, TEC), having at least one switching center (VER) which is set up for holding and forwarding calls,
characterized in that the telecommunications system (SYS) is set up such that, when at least one call (ANR) arrives for a first connection (A) while the first connection (A) is actively engaged in a call with a second connection (B), the connection to the second connection (B) is held, and the call a rriving at the first connection (A) is held on request, and, after entering a telephone number (RUF) which is associated with the further connection (D), the arriving call is forwarded to the further connection (D) and the call connection between the first connection and the second connection can be resumed.

5. The telecommunications system as claimed in claim 4, characterized in that a switching center (VER) is provided, which is associated with the first connection (A) and is set up for holding calls wh ich arrive for the first connection (A), on request by this connection (A).

6. The telecommunications system as claimed in claim 4 or 5,
characterized in that the telecommunications system is set up for transmitting to the switching center (VER) a reques t from the first connection (A) to forward the held call to the third connection (D).
